(19) United States
(12) Patent Application Publication
(10) Pub. No.: US 2020/0157976 A1
(43) Pub. Date: May 21, 2020

(54) DRIVE FORCE TRANSMISSION MECHANISM

(71) Applicant: TOYOTA JIDOSHA KABUSHIKI KAISHA, Toyota-shi (JP)

(72) Inventors: Takuya TAKAHASHI, Nisshin-shi (JP); Atsushi HOSHIMIYA, Toyota-shi (JP); Hidetoshi HIROSE, Nisshin-shi (JP); Takashi KAWANAKA, Toyota-shi (JP)

(73) Assignee: TOYOTA JIDOSHA KABUSHIKI KAISHA, Toyota-shi (JP)

(21) Appl. No.: 16/601,910

(22) Filed: Oct. 15, 2019

(30) Foreign Application Priority Data
Nov. 21, 2018 (JP) 2018-218475

(51) Int. Cl. F01L 1/02; F16H 7/18; F16H 7/06; F01L 1/053; F01L 1/46

(52) U.S. Cl. CPC F01L 1/022; F16H 7/18; F16H 7/06; F01L 2250/02; F01L 1/46; F01L 2001/0537; F01L 2101/00; F01L 1/053

(57) ABSTRACT

A drive force transmission mechanism includes: a sprocket attached to a camshaft; a timing chain meshing with the sprocket and transmitting a drive force of a crankshaft to the camshaft; and a guide unit facing the timing chain, wherein the guide unit is located within a mesh zone where the timing chain and the sprocket mesh with each other, is not located in a zone other than the mesh zone, and has a length at least equal to a length of one link of the timing chain

### CROSS-REFERENCE TO RELATED APPLICATION

This application is based upon and claims the benefit of priority of the prior Japanese Patent Application No. 2018-218475, filed on Nov. 21, 2018, the entire contents of which are incorporated herein by reference.

### TECHNICAL FIELD

The present disclosure relates to a drive force transmission mechanism.

### BACKGROUND

In some internal-combustion engines, a timing chain is used to transmit the drive force of the crankshaft to the camshaft. In particular, the timing chain is made to mesh with the sprocket attached to the camshaft. When the internal-combustion engine is started, a force is applied to the timing chain, and the timing chain may skip over the tooth of the sprocket. A technique that uses a guide unit that the timing chain is in contact with and slides along to inhibit the tooth skipping of the timing chain is known as disclosed in Japanese Patent Application Publication No. 2012-47262 (hereinafter, referred to as Patent Document 1).

### SUMMARY

It is therefore an object of the present disclosure to provide a low-cost drive force transmission mechanism that inhibits the tooth skipping of a timing chain.

The above object is achieved by a drive force transmission mechanism including: a sprocket attached to a camshaft; a timing chain meshing with the sprocket and transmitting a drive force of a crankshaft to the camshaft; and a guide unit facing the timing chain, wherein the guide unit is located within a mesh zone where the timing chain and the sprocket mesh with each other, is not located in a zone other than the mesh zone, and has a length at least equal to a length of one link of the timing chain.

### BRIEF DESCRIPTION OF THE DRAWINGS

FIG. 1 is a plan view illustrating a head cover of an internal-combustion engine;

FIG. 2A is a front view illustrating a drive force transmission mechanism, and FIG. 2B is a cross-sectional view illustrating the drive force transmission mechanism;

FIG. 3A is a plan view illustrating a timing chain, and FIG. 3B and FIG. 3C are diagrams illustrating the timing chain and a guide unit side by side;

FIG. 4 is a front view illustrating a drive force transmission mechanism in accordance with a second embodiment; and

FIG. 5 is a front view illustrating a drive force transmission mechanism in accordance with a third embodiment.

### DETAILED DESCRIPTION

The guide unit in Patent Document 1 is arranged so as to overlap with a plurality of sprockets. The provision of such a large guide unit increases the cost.

### First Embodiment

Hereinafter, drive force transmission mechanisms of embodiments will be described with reference to the accompanying drawings. The drive force transmission mechanism is applied to an internal-combustion engine such as, but not limited to, a double overhead cam type straight-three engine.

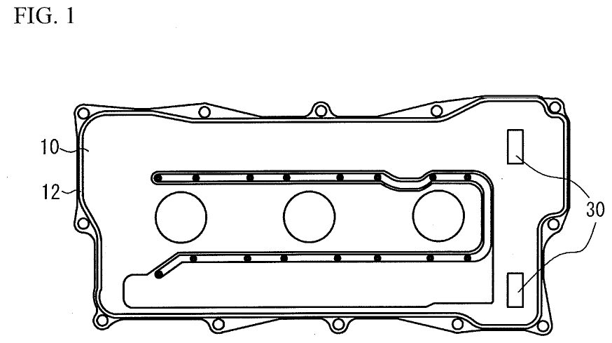

FIG. 1 is a plan view illustrating a head cover 10 of an internal-combustion engine, and illustrates the head cover 10 as viewed from below. The head cover 10 is made of, for example, a resin. A seal member 12 is formed in the peripheral part of the head cover 10, and two guide units 30 are located on the undersurface of the head cover 10.

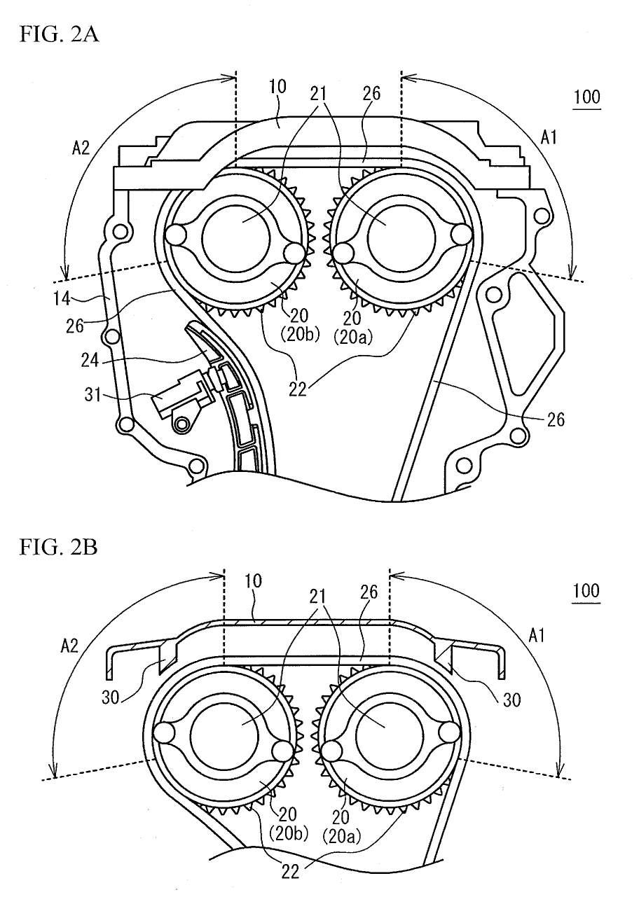

FIG. 2A is a front view illustrating a drive force transmission mechanism 100, and FIG. 2B is a cross-sectional view illustrating the drive force transmission mechanism 100. Both FIG. 2A and FIG. 2B illustrate the drive force transmission mechanism 100 as viewed from the Fr side. As illustrated in FIG. 2B, the drive force transmission mechanism 100 includes sprockets 20, a timing chain 26, and the guide units 30. Since the guide units 30 are hidden behind the head cover 10, the illustration of the guide units 30 is omitted in FIG. 2A. In addition, in FIG. 2B, the illustration of a chain case 14, a chain slipper 24, and a chain tensioner 31 is omitted.

As illustrated in FIG. 2A, the head cover 10 is mounted over the chain case 14. Two sprockets 20, two camshafts 21, and the timing chain 26 are arranged in the area surrounded by the head cover 10 and the chain case 14. The chain case 14, the sprockets 20, and the timing chain 26 are made of, for example, a metal.

One of the two camshafts 21 opens and closes an intake valve, and the other opens and closes an exhaust valve. The sprocket 20 is a gear wheel having teeth 22 on the outer periphery thereof, and is attached to the end of the camshaft 21. One of the sprockets 20 is also called a sprocket 20a, and the other is also called a sprocket 20b.

The timing chain 26 is wound around the two sprockets 20, and is wound around a sprocket attached to the end of a crankshaft (not illustrated). The drive force of the crankshaft is transmitted from the timing chain 26 and the sprockets 20 to the camshafts 21, and thereby, the camshafts 21 rotate.

The timing chain 26 meshes with some of the teeth 22 of the sprocket 20. The zone where the sprocket 20a and the timing chain 26 mesh with each other is defined as a mesh zone A1, and the zone where the sprocket 20b and the timing chain 26 mesh with each other is defined as a mesh zone A2. The chain tensioner 31 adjusts the tension of the timing chain 26 by pressing the timing chain 26 through the chain slipper 24.

As illustrated in FIG. 2B, two guide units 30 corresponding to two sprockets 20 are provided to the head cover 10. One of the two guide units 30 is located within the mesh zone A1 and faces the sprocket 20a, while the other one is located within the mesh zone A2 and faces the sprocket 20b. No guide unit 30 is provided in the zone other than the mesh zones A1 and A2.

The guide units 30 are formed of, for example, a resin identical to that of the head cover 10, and protrude from the undersurface of the head cover 10 toward the sprockets 20 and the timing chain 26. The undersurface of the guide unit 30 (the surface facing the timing chain 26) curves along the timing chain 26 and is located away from the timing chain 26. Thus, a gap of several millimeters is formed between the undersurface of the guide unit 30 and the timing chain 26.

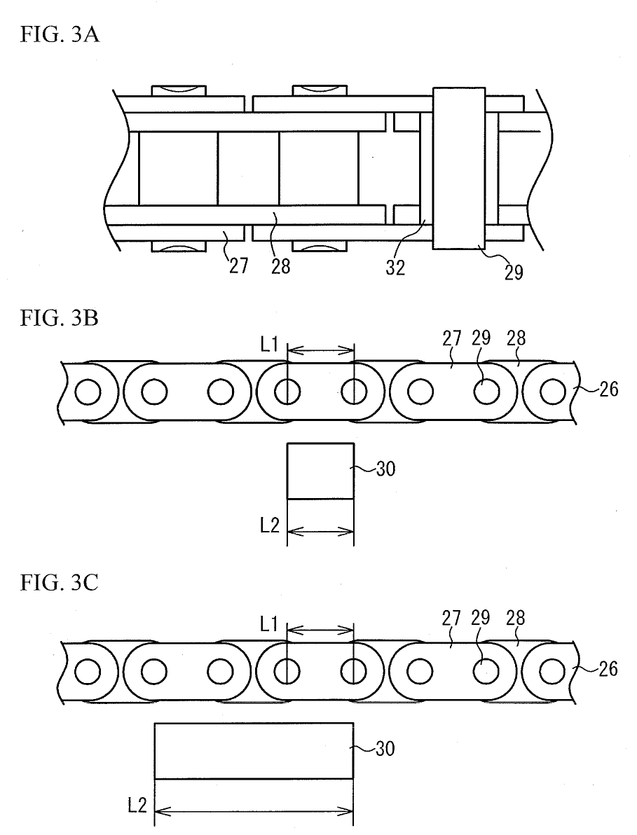

FIG. 3A is a plan view illustrating the timing chain 26. The inside of the timing chain 26 is partially illustrated in FIG. 3A. As illustrated in FIG. 3A, the timing chain 26 includes plates 27 and 28, and the plate 27 and the plate 28 are interlinked by, for example a pin 29 and a bush 32. The tooth 22 of the sprocket 20 meshes with the space between the pins 29.

FIG. 3B and FIG. 3C illustrate the timing chain 26 and the guide unit 30 side by side, and illustrate the timing chain 26 as viewed from the side. The distance between the adjacent pins 29 corresponds to the length L1 of one link of the timing chain 26. In the example illustrated in FIG. 3B, the length L2 of the guide unit 30 is equal to the length L1 of one link of the timing chain 26. In the example illustrated in FIG. 3C, the length L2 is greater than the length L1, and the guide unit 30 faces three links of the timing chain 26. As seen above, the length L2 of the guide unit 30 is at least equal to the length L1 of one link, and may be greater than the length L1.

In the first embodiment, the guide units 30 are located within the respective mesh zones A1 and A2 where the sprocket 20 and the timing chain 26 mesh with each other, and each of the guide units 30 has a length L2 at least equal to the length of one link. This configuration inhibits the timing chain 26 from skipping over the tooth of the sprocket 20.

When the timing chain 26 meshes with the sprockets 20, the timing chain 26 is separated from the guide units 30, and moves without being in contact with the guide units 30. Thus, the noise made by the timing chain 26 moving while being in contact with the guide units 30 is prevented, and increase in friction due to the contact between the timing chain 26 and the guide units 30 is prevented. When a centrifugal force is applied to the timing chain 26 as the camshaft 21 rotates, and the timing chain 26 comes close to fail to mesh with the tooth 22 of the sprocket 20, the guide units 30 come in contact with the timing chain 26. Therefore, the tooth skipping of the timing chain 26 is inhibited.

The guide units 30 are provided within the respective mesh zones A1 and A2, and are not provided in any zone other than the mesh zones. Thus, compared with the large guide unit that also covers the zones other than the mesh zones, the guide unit 30 is reduced in size and the cost is reduced.

The length L2 of the guide unit 30 may be greater than the length L1, and may be equal to or greater than the length of two links or equal to or greater than the length of three links. The guide unit 30 may cover the entire of one mesh zone. However, as the guide unit 30 becomes larger, the effect for inhibiting the tooth skipping is improved, but the cost increases. As illustrated in FIG. 3B and FIG. 3C, the length L2 of one guide unit 30 is at least equal to or greater than the length L1 of one link, and is equal to the length L1, for example. The inhibition of the tooth skipping is possible, and the cost is reduced because the guide unit 30 is reduced in size.

Since the guide unit 30 is made of a resin, the guide unit 30 is lightweight compared with the guide unit made of a metal, and the large sound is hardly made when the guide unit 30 comes in contact with the timing chain 26.

In some embodiments, the head cover 10 and the guide units 30 are formed of the same resin. When the head cover 10 and the guide units 30 are formed of the same resin, the head cover 10 and the guide units 30 can be formed simultaneously by, for example, mold injection, and thereby, the cost is further reduced. The guide units 30 may be fainted separately from the head cover 10 regardless of whether the guide units 30 are formed of a resin identical to that of the head cover 10 or a resin different from that of the head cover 10. In this case, the guide units 30 are attached to the head cover 10. The positions of the guide units 30 are not limited to the positions illustrated in FIG. 2B. The guide units 30 can be located in desired positions on the undersurface of the head cover 10 as long as the desired positions are located within the respective mesh zones A1 and A2. For example, the guide units 30 may be located in the positions more suitable to inhibit the tooth skipping.

The first embodiment has described an example in which the internal-combustion engine includes two sprockets 20 and two camshafts 21. The number of the sprockets 20 may be two or more depending on the number of the camshafts 21. The guide unit 30 corresponding to at least one of the sprockets 20 is provided, and the guide units 30 corresponding to other sprockets 20 are not necessarily provided. However, to inhibit the tooth skipping, a plurality of the guide units 30 may be provided. In particular, the guide unit 30 may be provided in each of the mesh zones where the timing chain 26 and the sprocket 20 mesh with each other.

The drive force transmission mechanism 100 can be applied to the internal-combustion engine including the sprocket 20 and the timing chain 26. In particular, it is effective to apply the drive force transmission mechanism 100 to the internal-combustion engine in which the tooth skipping of the timing chain 26 easily occurs. As the change in the speed of the cam increases, the centrifugal force causes the timing chain 26 to sag, and the tooth skipping of the timing chain 26 is likely to occur. For example, in the straight-four (L4) engine, the cams cancel each other's effect of the rotation. However, in the straight-three (L3) engine, the degree of the cancellation between the cams is small, and the centrifugal force due to the variation in the cam torque is large. Therefore, the tooth skipping easily occurs in the L3 engine. Therefore, when the drive force transmission mechanism 100 is applied to the L3 engine, the possibility of the tooth skipping is significantly reduced. The drive force transmission mechanism 100 can be applied to engines other than the L3 engine and the L4 engine.

### Second Embodiment

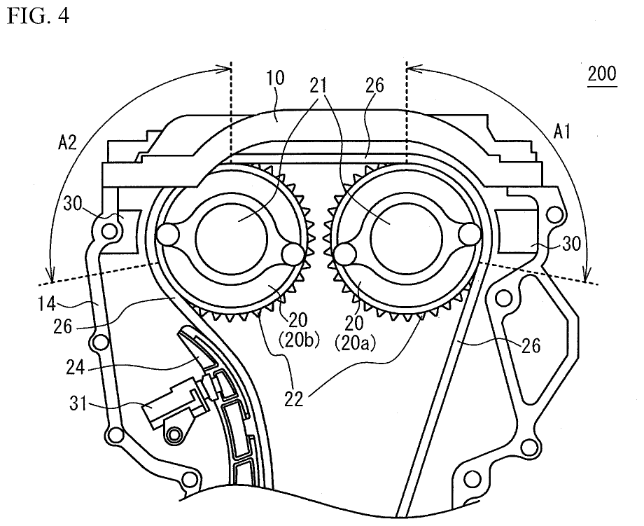

A drive force transmission mechanism 200 in accordance with a second embodiment will be described. The description of the components identical to those in the first embodiment will be omitted. FIG. 4 is a front view illustrating the drive force transmission mechanism 200 in accordance with the second embodiment. The two guide units 30 are formed separately from the head cover 10, and attached to the surfaces facing the sprockets 20 of the chain case 14. The guide units 30 are located within the respective mesh zones A1 and A2.

The second embodiment inhibits the tooth skipping of the timing chain 26. In addition, the guide units 30 can be provided in desired positions that are within the mesh zones A1 and A2 and on the inner wall of the chain case 14.

### Third Embodiment

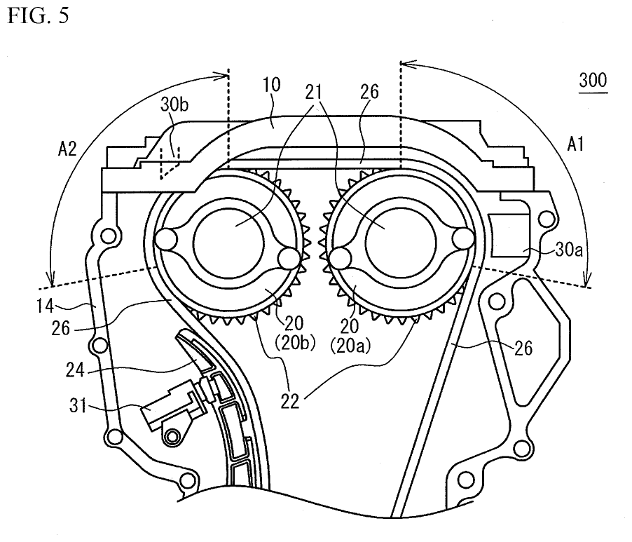

A drive force transmission mechanism 300 in accordance with a third embodiment will be described. The description of the same components as those of the second embodiment will be omitted. FIG. 5 is a front view illustrating the drive force transmission mechanism 300 in accordance with the third embodiment. A guide unit 30b, indicated by a dotted line, of the two guide units 30 is formed of a resin identical to that of the head cover 10, and is located within the mesh zone A2. A guide unit 30a indicated by a solid line is formed separately from the head cover 10, is attached to the surface facing the sprocket 20 of the chain case 14, and is located within the mesh zone A1. The third embodiment inhibits the tooth skipping of the timing chain 26.

Two or more guide units 30 may be provided in accordance with the number of the sprockets 20. It is sufficient if at least one of a plurality of the guide units 30 is provided to the head cover 10, and another one is provided to the chain case 14. The guide units 30 may be provided to the component other than the head cover 10 and the chain case 14 as long as the guide units 30 are located within the respective mesh zones A1 and A2. For example, the position of the guide unit 30 may be adjusted according to the shapes, the sizes, and the layout of the head cover 10, the chain case 14, and the sprocket 20.

Although some embodiments of the present disclosure have been described in detail, the present disclosure is not limited to the specific embodiments but may be varied or changed within the scope of the present disclosure as claimed.

What is claimed is:

1. A drive force transmission mechanism comprising:
a sprocket attached to a camshaft;
a timing chain meshing with the sprocket and transmitting a drive force of a crankshaft to the camshaft; and
a guide unit facing the timing chain,
wherein the guide unit is located within a mesh zone where the timing chain and the sprocket mesh with each other, is not located in a zone other than the mesh zone, and has a length at least equal to a length of one link of the timing chain.

2. The drive force transmission mechanism according to claim 1, wherein
the guide unit is made of a resin.

3. The drive force transmission mechanism according to claim 1, further comprising
a head cover covering the camshaft, the sprocket, and the timing chain, wherein
the guide unit is formed of a resin identical to a resin of the head cover, and
the guide unit protrudes from a surface of the head cover toward the timing chain, the surface of the head cover facing the timing chain.

4. The drive force transmission mechanism according to claim 1, further comprising
a case covering the timing chain and the sprocket,
wherein the guide unit is provided to the case.

5. The drive force transmission mechanism according to claim 1, wherein
the sprocket includes a plurality of sprockets,
the timing chain meshes with the sprockets, and
the guide unit is provided in each of the mesh zones where the timing chain meshes with the sprockets.

6. The drive force transmission mechanism according to claim 5, further comprising:
a head cover covering the camshaft, the sprocket, and the timing chain; and
a case covering the timing chain and the sprocket, wherein
the guide unit includes a plurality of guide units,
at least one of the guide units is formed of a resin identical to that of the head cover, and protrudes from a surface of the head cover toward the timing chain, the surface of the head cover facing the timing chain, and
at least another one of the guide units is provided to the case.
